(19) United States
(12) Patent Application Publication
(10) Pub. No.: US 2026/0127450 A1
(43) Pub. Date: May 7, 2026

(54) DASHBOARD TO SELECT QUANTUM AND CLASSICAL ALGORITHMS FOR MAC PRICE OPTIMIZATION

(71) Applicant: Optum Services (Ireland) Limited, Dublin (IE)

(72) Inventors: Botond TARCSAY, Dublin (IE); Joao Gabriel TEIXEIRA NOGUEIRA, Kildare (IE); Ankit AGARWAL, Dublin (IE); Michael R. GIBSON, Dublin (IE)

(21) Appl. No.: 18/939,857

(22) Filed: Nov. 7, 2024

(51) Int. Cl. G06N 5/022; G06F 16/25

(52) U.S. Cl. CPC G06N 5/022; G06F 16/254

(57) ABSTRACT

Various embodiments of the present disclosure provide an optimization model technique that improves the functionality of a computer in various aspects. The techniques comprise receiving a request that identifies an input dataset and a set of input performance parameters, extracting one or more features of the input dataset, determining a subset of target datasets from a set of historical datasets associated with an optimization model based on a comparison between the one or more features of the input dataset and one or more historical features associated with a historical dataset of the set of historical datasets, extracting a set of historical performance parameters from the subset of target datasets, and outputting an optimization model indicator corresponding to the optimization model based on a comparison between the set of historical performance parameters and the set of input performance parameters.

### BACKGROUND

Various embodiments of the present disclosure address technical challenges related to machine learned technology, more specifically, determination of an optimization model that meets certain performance parameters for a particular dataset. In various domains, an optimization model is needed to solve various optimization problems. In many cases, determining the best model for an optimization task is a highly complex problem that requires expertise in the field. The selection of a suitable optimization model is limited by the knowledge of user's involved in the selection process, given that all optional models cannot be run without resulting in unnecessary costs and time. If the best model for an optimization task is not correctly determined, this may result in high costs, a long runtime, and suboptimal results.

### BRIEF DESCRIPTION OF THE DRAWINGS

FIG. 1 depicts an example overview of an architecture in accordance with some embodiments of the present disclosure.

FIG. 2 depicts an example predictive data analysis computing entity in accordance with some embodiments of the present disclosure.

FIG. 3 depicts an example client computing entity in accordance with some embodiments of the present disclosure.

FIG. 4 depicts a dataflow diagram of an end-to-end optimization model selection architecture in accordance with some embodiments of the present disclosure.

FIG. 5 depicts an operational example of a request in accordance with some embodiments of the present disclosure.

FIG. 6 depicts an operational example of an input dataset in accordance with some embodiments of the present disclosure.

FIG. 7 depicts an operational example of a user interface in accordance with some embodiments of the present disclosure.

FIG. 8 depicts an operational example of a knowledge database in accordance with some embodiments of the present disclosure.

FIG. 9 depicts a flowchart diagram of an optimization process in accordance with some embodiments of the present disclosure.

FIG. 10 depicts a flowchart diagram of a target dataset extraction process in accordance with some embodiments of the present disclosure.

FIG. 11 depicts a flowchart diagram of a parameter-level distance measure determination process in accordance with some embodiments of the present disclosure.

### DETAILED DESCRIPTION

Various embodiments of the present disclosure provide machine learned architectures and pipelines that improve the functionality of a computer with respect to various computing tasks, including determining an optimization model for a particular dataset according to processing constraints of a computing environment. To achieve this, some embodiments of the present disclosure provide an optimization technique that extracts features from an input dataset and, using these extracted features, selects an optimization model from a set of available models for processing the input dataset. By preselecting a model, before the application of the model to the input dataset, the optimization technique may improve a computer's performance with respect to optimization tasks. This, in turn, leads to improved computer functionalities by improving the accessibility of optimization models to computers with limited resources (e.g., user device) without constraining an optimization task to such environments.

Moreover, in some embodiments, the optimization technique may in integrate a feedback loop into an optimization task to continuously learn and adapt model selection techniques to different environments. For example, after a model is preselected for an optimization task, the performance of the model may be recorded, the dataset may be vectorized, and the vectorized dataset may be stored with parameters reflective of the model's recorded performance. By doing so, the optimization techniques of the present disclosure may provide an adaptive interface for learning computer efficiencies with respect to continuously changing optimization models and computing environments. These flexibilities improve optimization model development, deployment, and use over time as the feedback loop mechanism may be applied to detect performance drifts and other predictive trends for models as the models are used across different computing environments, datasets, and times.

Examples of technologically advantageous embodiments of the present disclosure comprise improved optimization techniques, among other aspects of the present disclosure. Other technical improvements and advantages may be realized by one of ordinary skill in the art.

### I. OVERVIEW OF EMBODIMENTS

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

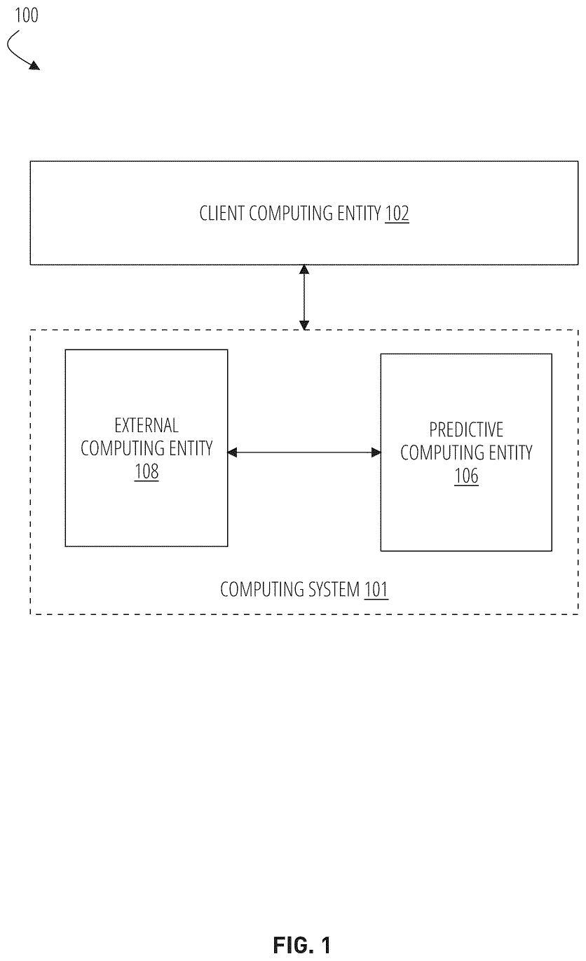

FIG. 1 depicts an example overview of an architecture 100 in accordance with some embodiments of the present disclosure. The architecture 100 comprises a computing system 101 configured to receive a request, such as a request that provides a dataset and performance parameters, and/or the like, from client computing entities 102, process the request, and provide an optimization model indicator in response to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate candidate outputs, candidate output scores, and/or other machine learned outputs. The models may be adapted to a differential request handling engine and/or complementary scoring mechanism that may collectively process a request and provide an optimization model indicator using a modular model ensemble. Some techniques of the present disclosure may adapt traditional models to a cohesive framework, such as the modular model ensemble, for more efficiently handling portions of the request handling process.

In some embodiments, the computing system 101 may communicate with at least one of the client computing entities 102 using one or more communication networks. Examples of communication networks comprise any wired or wireless communication network comprising, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more optimization techniques described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage an input dataset or a historical dataset to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

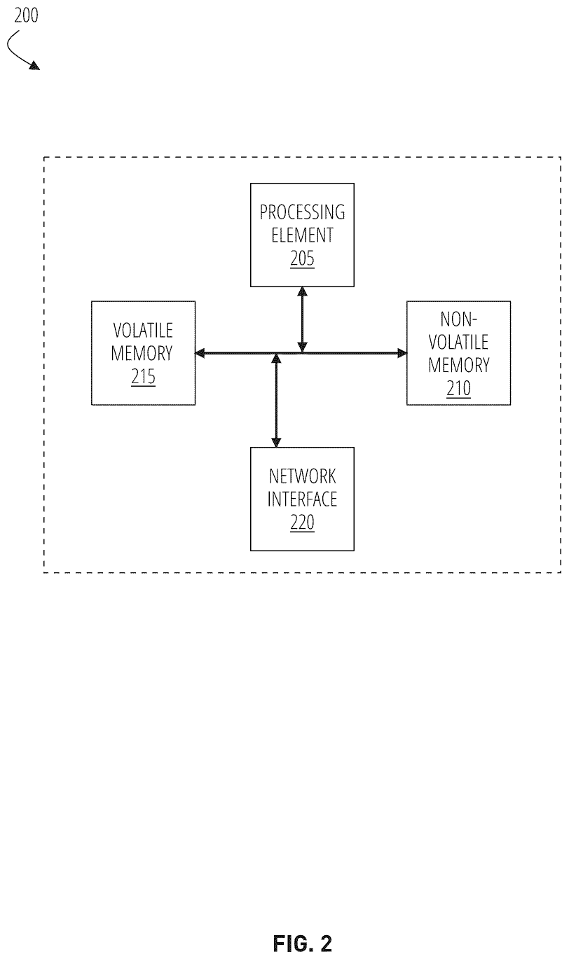

FIG. 2 depicts an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), as discussed above.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium comprising random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (comprising various levels), flash memory, register memory, and/or the like. It will be appreciated that where embodiments are described to use a computer-readable storage medium, other types of computer-readable storage media may be substituted for or used in addition to the computer-readable storage media described above.

As will be recognized, the non-volatile memory 210 and/or the volatile memory 215 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, comprising as computer program products that comprise articles of manufacture. Such computer program products may comprise one or more software components comprising, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (comprising volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

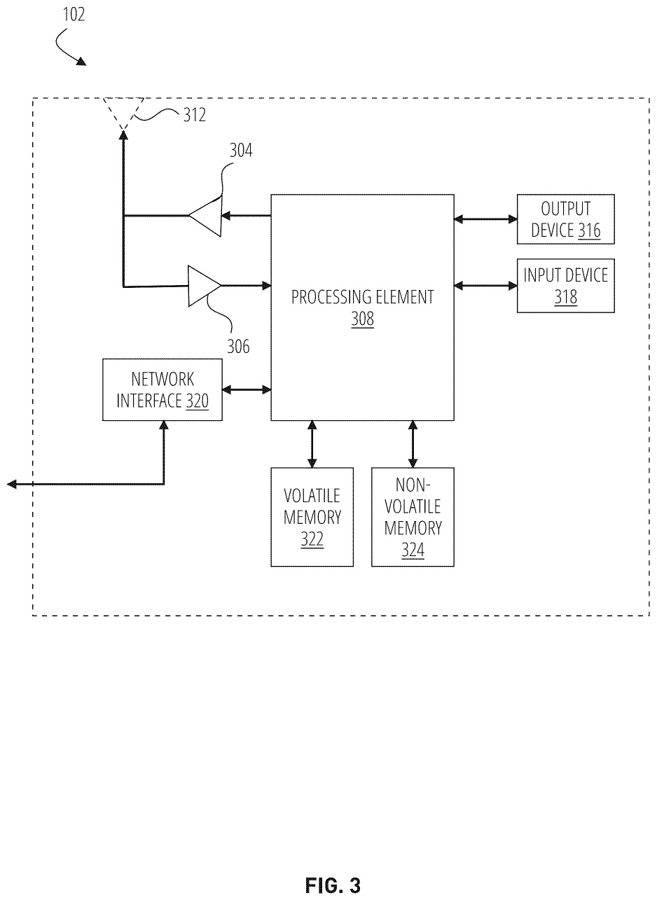

FIG. 3 depicts an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., comprising executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, comprising Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, comprising cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies comprising RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. EXAMPLE SYSTEM OPERATIONS

As indicated, various embodiments of the present disclosure make important technical contributions to determination of a best optimization model for a particular dataset according to provided performance parameters. In particular, systems and methods are disclosed herein that implement optimization and data compression techniques to improve selection of optimization models for an optimization task. By doing so, the optimization and data compression techniques of the present disclosure enable improved data storage and retrieval processes that, when executed on a computer, enables the dynamic selection of an optimization model for a particular dataset according to performance constraints of a computer. This, in turn, may improve the functionality of a computer with respect to various computing tasks, comprising minimizing cost and storage associated with running optimization models on a dataset and the like.

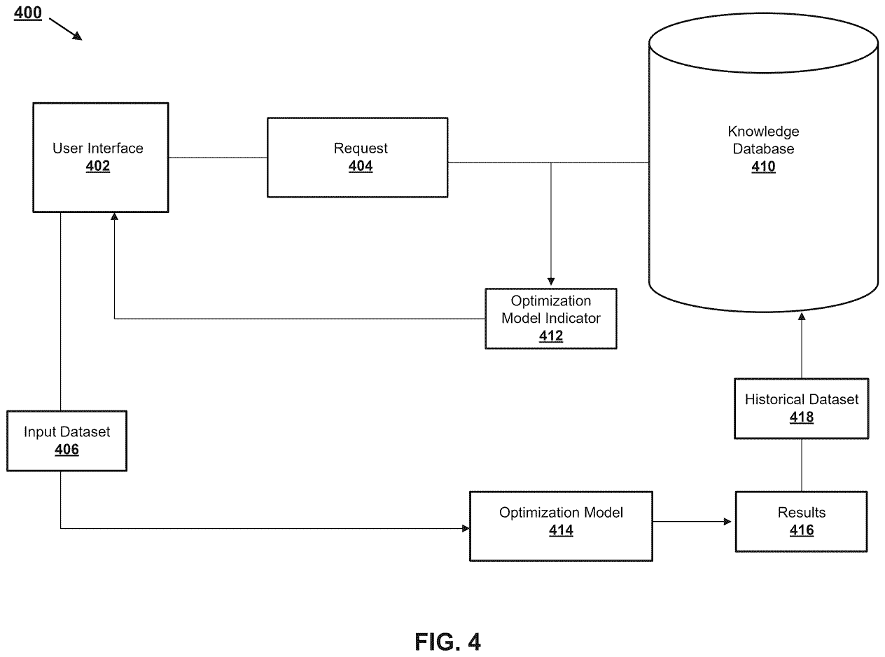

FIG. 4 is a dataflow diagram 400 of a dataflow diagram of an end-to-end optimization model selection architecture in accordance with some embodiments of the present disclosure. As shown in dataflow diagram 400, a request 404 may be prompted via a user interface 402 for an optimization process. In response to a request 404, a computing entity, such as the computing system 101 of the present disclosure, may implement an optimization process based on the parameters of the request 404. To do so, the computing system 101 may extract one or more features from an input dataset 406 identified by the request 404, vectorize the features to generate a vectorized representation of the input dataset 406 and perform one or more vector comparisons between the vectorized representation of the input dataset 406 and a set of historical datasets of a knowledge database 410. By doing so, the computing system 101 may extract a subset of target datasets associated with an input dataset 406 that have been previously processed using one or more of a plurality of different optimization techniques. This, in turn, allows for the selection of an optimization model 414 for processing the input dataset 406 based on a predicted performance of the optimization model 414 that is tailored to the specific features of an input dataset 406. In this manner, the computing system 101 may perform a sequence of preprocessing operations, before the optimization of an input dataset 406, to preselect an optimization model 414 from a set of accessible models and then apply the preselect model to the input dataset 406. As described herein, the preprocessing steps may be tailored to a set of input performance parameters of the request 404 to tailor the selection of the optimization model 414 to a set of user or system defined computer processing requirements and, by doing so, leads to improvement in optimization modeling that enable the tailored use of limited computer resources to different client requests. Ultimately, this leads to improved computer functionalities with respect to the application of optimization modeling techniques within a computer environment that improve access to optimization model 414, without reducing their performance.

In some embodiments, a request 404 is received that identifies an input dataset 406 and a set of input performance parameters. In some embodiments, one or more features of the input dataset 406 are extracted. In some embodiments, a subset of target datasets from a set of historical datasets associated with an optimization model 414 are determined based on a comparison between the one or more features of the input dataset 406 and one or more historical features associated with each historical dataset 418 of the set of historical datasets. In some embodiments, a set of historical performance parameters are extracted from the subset of target datasets. In some embodiments, an optimization model indicator 412 corresponding to the optimization model 414 is outputted based on a comparison between the set of historical performance parameters and the set of input performance parameters.

In some embodiments, a request 404 is a message for a computing service. For example, a request 404 may comprise an API request 404, call, message, and/or the like for a service, such as one or more services of the present disclosure. In some examples, a request 404 may be initiated by a user via a user interface 402. In addition, or alternatively, a request 404 may be initiated by an automated agent, responsive to one or more request triggers, and/or the like.

In some examples, a request 404 may identify one or more request parameters. The request parameters, for example, may identify an input dataset 406, one or more input performance parameters, and/or the like. In some examples, the one or more request parameters may be defined for a requested service. By way of example, the request parameters may identify an input dataset 406 for analysis by a requested service. In addition, or alternatively, the request parameters may comprise performance parameters that identify requested metrics for analysis by the request service, such as a current performance value, a target performance value, a lookback window, a variable level, a threshold delta to the target performance value, a run time threshold, a threshold variable value, and/or the like. The performance parameters, for example, may define a plurality parameters of an optimization model 414 associated with the requested service.

In some examples, a request 404 may be initiated via a sequence of request prompts. For instance, an initial request may trigger one or more prompts (e.g., for a user, automated agent) for the one or more request parameters. The sequence of request prompts may be provided based on a request profile, an input dataset 406, a requested service, and/or the like.

In some examples, a request 404 may be received, forward to, and/or otherwise recognized by a computing system 101 configured to perform the requested service. Responsive to the request 404, the computing system 101 may extract one or more request parameters from the request 404 and initiate the requested service based on the one or more request parameters and the input dataset 406. By way of example, the request 404 may comprise an optimization request for an optimization process and, responsive to the request 404, the computing system 101 may initiate an optimization service to detect an optimization model 414 for the input dataset 406.

In some embodiments, an input dataset 406 is a dataset associated with a request 404. The input dataset 406 may comprise a data structure which defines a plurality of dataset entries. The data structure, for example, may comprise a relational database, a linked list, a graph database, and/or the like. As one example, the input dataset 406 may comprise a comma-separated values (CSV) file or another representation of a table. In some examples, the data entries of the input dataset 406 may comprise a plurality of entry features and/or dataset features for a requested service. For example, an input dataset 406 may comprise one or more pre-defined headings for the entry features. The input dataset 406 may contain data aggregated over one or more time periods, such as daily, weekly, monthly, and/or any other time periods. In some examples, the entry features may comprise a date feature within the input dataset 406. As described herein, the date feature may be optional, define a constant bound, and/or by modifiable and/or static based on the input dataset 406.

In some examples, the input dataset 406 and/or the features thereof may be based on a prediction domain and/or the requested service within the prediction domain. For example, in a computer performance domain, an input dataset 406 may comprise an aggregated computer performance report that comprises a list of computer identifiers (e.g., Internet Protocol addresses), a current processing speed, a current memory allocation, processing resources accessibility bounds, and/or the like. As another example, for a clinical domain, an input dataset 406 may comprise one or more Maximum Allowable Cost (MAC) lists, such as a list of Generic Product Identifiers (GPI), a current price of each GPI, an average wholesale price for each GPI, the bounds of the price (e.g., maximum and minimum prices), average wholesale price percentage discount, drug quantity, and a utilization (i.e., the number of times these were sold).

In some embodiments, a knowledge database 410 comprises one or more data structures, memory locations, and/or the like that are maintained and/or otherwise accessible, to a computing system 101. The knowledge database 410 may comprise any type of one or more storage data structures, comprising relational databases, linked lists, graph-based data structures, and/or the like. In some examples, a knowledge database 410 may comprise a set of historical vectors respectively corresponding to a set of historical datasets previously processed by one or more optimization models 414. In some examples, the knowledge database 410 may comprise a set of historical performance vectors for the set of historical vectors. For instance, a historical vector may correspond to one or more historical performance vectors reflective of a performance of one or more optimization models 414 with respect to a corresponding historical dataset 418. By way of example, a knowledge database 410 may comprise a set of historical performance entries that respectively describe a set of feature-parameter pairs.

In some embodiments, an optimization model 414 is a model that takes a dataset as input and solves an optimization task based on the provided data. This may also refer to the model determined by the knowledge database 410 to be the best match model for the provided input dataset 406 and input performance parameters. In the context of drug pricing, the optimization model 414 may optimize the drug pricing process for the drugs detailed in the input dataset 406. The computing system 101 and knowledge database 410 may provide data that has been run with a variety of different optimization models 414. These models may comprise Nelder-Mead minimization, Nevergrad minimization, Particle Swarm Optimization, Simulated Annealing, Quantum Annealing Optimization, Basin-hopping, Quantum Approximate Optimization, Hybrid Sampling (i.e. quantum/classical), and/or the like. These optimization models 414 are hyper-parametrized and auto-tuned to the underlying data and run with a selected specification and platform. When the model is run on the input dataset 406, it provides an optimized price for each of the GPIs included in the input dataset 406. During this process, the optimization model 414 attempts to modify the prices in a way to reach the target performance value.

In some embodiments, an optimization model indicator 412 comprises an indication, provided by the computing system 101, of the optimization model 414 that is a best match based on the input dataset 406 and one or more input performance parameters. The optimization model indicator 412 may indicate the best match out of the available optimization models 414. The best match may fit all the input performance parameters, or it may meet a portion of the input performance parameters of the available optimization models 414. The difference between run time threshold, threshold variable value, and closeness to target performance value is compared across cloud, local and quantum (where applicable) for each optimization model 414.

In some embodiments, a parameter-level distance measure is a measure referencing the distance between a historical performance parameter and a corresponding input performance parameter. A parameter-level distance measure may comprise a difference, ratio, and/or any other measure of distance between two values of a particular data type.

In some embodiments, a user interface 402 is a specialized interface comprising a plurality of interactive element within one or more sequential screens that are configured to initiate one or more portions of an optimization process. In some examples, the user interface 402 may organize the plurality of interactive elements within an optimization dashboard configured to prompt a user, automated agent, and/or the like with one or more request parameter options to incrementally generate a request 404 for an optimization process. The dashboard, for example, may provide a prompt for an input dataset 406, one or more input performance parameters, and/or the like. In some examples, the input dataset 406 and/or one or more input performance parameters may be prepopulated, and a prompt may provide confirmatory prompt to confirm and/or change the prepopulated parameters. In this manner, the user interface 402 may facilitate an automated request for an optimization process the automatically generates a request 404, initiates the request 404 to select an optimization model 414, and then executes the optimization model 414 to optimize an input dataset 406. In some embodiments, the optimization model 414 is automatically run on the input dataset 406 in response to an optimization model indicator 412 being determined.

The user interface 402 may provide a visual of actions and determinations of the optimization process. For example, responsive to a request 404, the user interface 402 may return an optimization model indicator 412, based on the determination made by the optimization process. In some examples, the user interface 402 may display an optimization model indicator 412 for each of a plurality of optimization models 414 that may achieve one or more of the input performance parameters of the request 404. In some examples, the user interface 402 may comprise a modifiable view in which a user and/or automated agent may scroll, zoom, and/or otherwise transition a viewpoint of the user interface 402 to view a plurality of different optimization models 414 for an input dataset 406.

In some examples, the user interface 402 may display an interactive link with an optimization model indicator 412 to enable the automatic execution of an optimization model 414 corresponding to the optimization model indicator 412. In some examples, a plurality of interactive links may be provided that respectively correspond to a plurality of optimization models 414. In some examples, a user and/or automated agent may execute (e.g., through a selection to the user interface 402) one or more of the optimization models 414 in parallel. Responsive to the completion of the optimization models 414, the user interface 402 (and/or dashboard thereof) may be updated to indicate a completion of the parallel optimization process and the results 416 of the run may be displayed via the user interface 402. Results 416 may comprise the threshold variable value, the run time threshold, a list of optimized prices, and/or the like.

In some embodiments, a target dataset is a historical dataset 418 from a knowledge database 410 with an association with an input dataset 406. A target dataset, for example, may comprise one of a subset of historical datasets from a set of historical datasets stored within a knowledge database 410. The subset of historical datasets may comprise one or more target datasets that meet or exceed a similarity threshold. In some examples, a computing system 101 may extract the one or more target datasets from the knowledge database 410 based on a comparison between an input dataset 406 and one or more of the set of historical datasets stored within a knowledge database 410. By way of example, the computing system 101 may generate a similarity score between an input dataset 406 and a historical dataset 418. The one or more target datasets may comprise a subset of historical datasets with similarity scores that meets, exceeds, or otherwise satisfies a similarity threshold. In addition, or alternatively, the one or more target datasets may comprise a subset of historical datasets associated with the top n similarity scores, where n is a real number (e.g., 5, 10, 100). As described herein, the similarities scores may be determined based on a comparison between the dataset features of an input dataset 406 with the data features of a historical dataset 418, such that a plurality of historical feature vectors may be leveraged (e.g., in lieu of historical datasets) to identify the one or more target datasets.

In some embodiments, a similarity score is a data entity that describes a statistical measure of a strength of a relationship between two datasets (e.g., an input dataset 406 and a historical dataset 418). A similarity score, for example, may comprise a data value (e.g., percentage, real number, ratio) that describes the similarity between one or more dataset features of an input dataset 406 and one or more features of a historical dataset 418. In some examples, a similarity score may be based on a vector comparison (e.g., cosine similarity) between a historical feature vector and an input feature vector. In some examples, a similarity score may be determined based on the combined distance across one or more of the dataset features of the input dataset 406 and the dataset features of historical dataset 418. In some examples, the similarity score may comprise a weighted similarity score. By way of example, a weighted similarity score may comprise an aggregated distance measurement in which a distance between one or more aggregated features are weighted in accordance with a weighting scheme (e.g., defining feature-level weighting coefficients). In some examples, the weighting scheme may be identified by a request 404.

In some embodiments, a similarity threshold is a static and/or configurable parameter for identifying a target dataset for an input dataset 406 from a knowledge database 410. A similarity threshold, for example, may comprise defined criteria for selecting a target dataset. In some examples, a similarity threshold may identify a maximum or minimum similarity score. In addition, or alternatively, a similarity threshold may identify a threshold number of target datasets (e.g., top n similarity scores).

In some embodiments, a computing system 101 comprises a computing entity, comprising one or more processors and/or memory storing instructions that, when executed by the one or more processors, cause the computing entity to perform one or more operations described herein. In some examples, a computing system 101 may comprise a user device, such as a mobile phone, desktop computer, laptop, and/or the like, a cloud-based server, and/or combinations thereof. The computing system 101 may comprise and/or have access to a knowledge database 410. A user (and/or automated agent) may be able to direct the computing system 101 to perform specific actions by interacting and submitting a request 404 using a user interface 402.

Once the request 404 is submitted by the user, the computing system 101 determines the best match optimization model 414 for the user-submitted input dataset 406. This determination is based on the uploaded data and an extensive pre-run of similar historical datasets. Once an optimization model 414 is selected and run on an input dataset 406, features of the input dataset 406 may be stored in the knowledge database 410 in the form of a historical feature vector 804. When another input dataset 406 is submitted the historical feature vectors stored in the knowledge database 410 may be used to identify historical datasets similar to the input dataset 406. The process begins by extracting features of the input dataset 406. Then a subset of target datasets from a set of historical datasets are determined based on a comparison between the extracted features of the input dataset 406 and the previously extracted features contained in the historical features vectors. Next a set of historical performance parameters is extracted from the subset of target datasets. And finally, an optimization model indicator 412 is outputted by the computing system 101, via the user interface 402, corresponding to an optimization model 414 determined as the best match for the input dataset 406 based on a comparison between the set of historical performance parameters and the set of input performance parameters. The optimization model indicator 412 is determined by precomputing several performance parameters associated with a particular optimization model 414 and a historical dataset 418 determined to be similar to the input dataset 406. The predicted performance parameters are based on hundreds or thousands of runs with similar data.

Based on the provided input dataset 406 and an extensive pre-run of similar data, the computing system 101 precomputes the performance parameters of the available optimization models 414. The predicted outcomes of running each optimization model 414 is based on hundreds or thousands of runs with different historical datasets, and their results 416 approximated based on the closeness of the historical dataset 418 to the input dataset 406. The similarity of the data, such as the dataset features of the input dataset 406, dataset features of stored historical datasets, and the user defined performance parameters will define which optimization model 414 associated with a historical dataset 418 will be indicated by the optimization model indicator 412.

The computing system 101 may utilize a feedback loop in order to improve the accuracy of the systems predictions of the optimization model 414 that is the best match for the input dataset 406 and input performance parameters. Once an optimization model 414 is run on an input dataset 406, the computing system 101s predicted performance parameters are compared to what the actual performance parameters were during the run. In this way, the historical data within the knowledge database 410 may be refined to better train the model and take account of factors such as drug mix, seasonal trends, population characteristics etc. that are typically more difficult to predict.

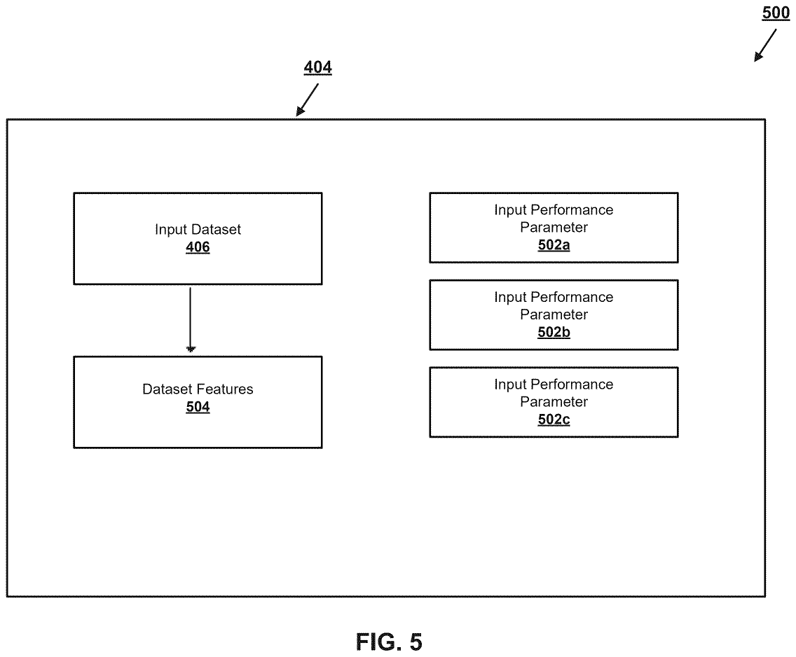

FIG. 5 is an operational example 500 of a request 404 in accordance with some embodiments of the present disclosure. As shown in the operational example 500, the request 404 may comprise one or more of an input dataset 406, a set of input performance parameters 502, or one or more features of the input dataset 406 which may be extracted after the input dataset 406 is uploaded to the user interface. In some examples, a request 404 may be initiated upon uploading the input data to a processing environment (e.g., cloud environment, local processing instance) of the computing system 101. Upon upload, one or more feature of the input dataset 406 may be extracted to generate a vectorized representation of the input dataset 406. In this way, the vectorized representation may replace the input dataset 406 to improve the preprocessing speeds of the computing system 101, while reducing processing resources expenditures.

In some examples, the request 404 may further comprise a set of input performance parameters 502 for constraining the selection of an optimization model a particular computing environment and/or processing use case. By way of example, the set of input performance parameters 502 may comprise a current performance value, a target performance value, a lookback window, a variable level, a threshold delta to the target performance value, a run time threshold, or a threshold variable value. These parameters allow for the selection of an optimization model that dynamically shifts the focus of the model (e.g., reduce processing requirements to enable client-side application of an optimization model, increase processing requirements to reduce processing times) based on the circumstances of an optimization task.

In some embodiments, an input performance parameter is a constraint for a request 404. The input performance parameter may specify one or more performance constraints for an optimization model based on an input dataset 406. An input performance parameter may comprise one of a plurality of input performance parameters 502 that may constrain an optimization model for an optimization task. By way of example, an input performance parameter may comprise an independent parameter for an optimization model.

In some embodiments, a dataset feature is an individually measurable property of a dataset. A dataset feature, for example, may comprise one or more size feature (e.g., a number of data entries, a number of rows, a number of nodes, a number of GPIs), one or more data type features (e.g., a number of data types, data type identifiers, unique type combinations), one or more formatting features (e.g., file size, data structure), one or more search space parameters (e.g., mean search space, minimum search space, maximum search space, standard deviation of search space, variance of search space, interquartile range of search space), one or more value distributions (e.g., number of outliers (+−2STD), T-test of the two dataset parameter ranges, a Pearson Correlation between two datasets, a Principal Component Analysis on both sets), and/or the like that define one or more representative characteristics of the input dataset 406. In some examples, a dataset feature may comprise an engineered feature that may be reflective of a predicted computing performance of one or more optimization models 414. A set of dataset features 504 may be extracted from the input dataset once a request is submitted. In this manner, a set of dataset features may be stored within a condensed data structure (e.g., lookup table) to represent a historical dataset without storing the entire dataset. By way of example, a historical dataset may be represented by a historical feature vector 804 that may comprise a sequence of dataset features reflective of a plurality of predictive attributes of the historical dataset.

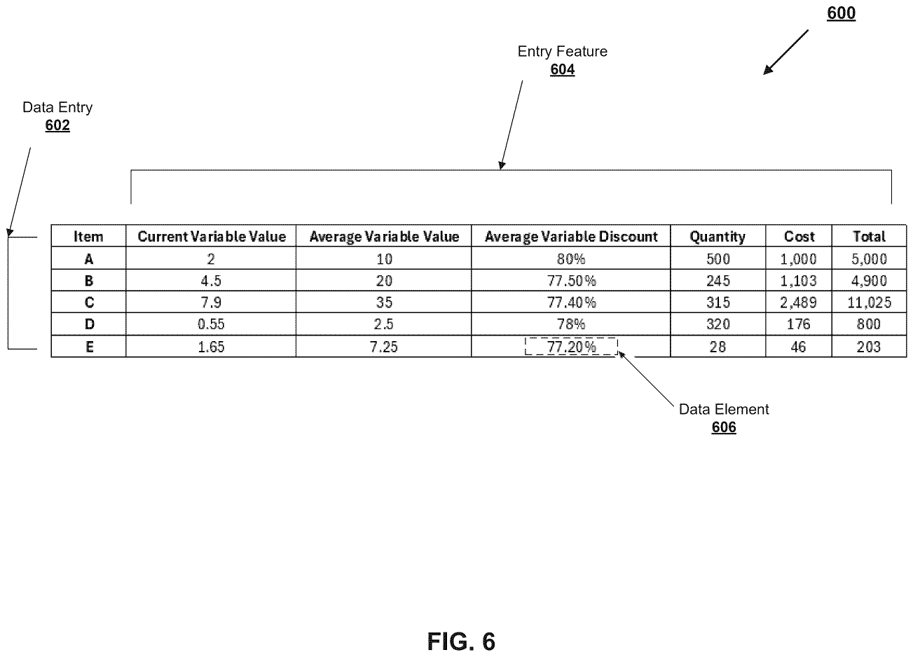

FIG. 6 is an operational example 600 of an input dataset in accordance with some embodiments of the present disclosure. As shown in the operational example 600, the input dataset may comprise any number of data elements defined by one or more data entries and one or more entry features 604. Each data element 606 may comprise an associated data type.

In some embodiments, a data entry 602 is a unit of an input dataset (e.g., row, node, vertex). A data entry 602, for example, may represent a discrete piece of data that provides specific information about an entity within the input dataset. In some examples, a data entry 602 may reflect one or more data elements for a particular entity. The data entry 602 and/or data elements thereof may depend on the prediction domain. A data entry 602 may comprise one or more data elements for a computer, a process, executable, and/or the like in a computer performance domain). As another example, in a clinical domain, a data entry 602 may comprise one or more data elements that may be reflective of a medication. By way of example, using a clinical domain for reference, a data entry 602 may comprise one or more data elements that detail a medication (e.g., dosage, type, ingredients) and one or more related pricing trends for the medication. In such a case, a data entry 602 may be used to determine the level of pharmacy reimbursement for a medication. For instance, the data entry 602 may refer to a specific National Drug Code (NDC), a GPI with a plurality of NDCs mapped to it, and/or the like and a price point for the NDC and/or GPI may be used to determine a level of pharmacy reimbursement for a prescription, disbursement, and/or use of the NDC.

In some examples, a data entry 602 may comprise metadata, such as timestamps, identifiers, categorizations, and/or the like, that provide context for one or more data elements. By way of example, each data entry 602 may correspond to a timestamp that identifies a timing of the reception or a recordation of the data entry 602 and/or one or more data elements therein. In some examples, a plurality of dataset entries from a data record may be processed to extract a plurality of data elements for an entity. In some examples, the plurality of data elements may be extracted based on the timestamps of the data entries. For instance, the plurality of data elements may be extracted from one or more of data entries associated with a timestamp that is within a threshold time period (e.g., one or more years, months, weeks, or days). Each data element 606 may identify a granular data point for maintaining an up-to-date and accurate representation of an entity's characteristics within an input dataset. In this respect, the plurality of data elements may depend on the information domain and/or the measured characteristics therein.

In some embodiments, a data type is a feature classification that describes a type and/or one or more common characteristics for a data element 606 of a data entry 602 within an input dataset (e.g., column header, node classification). For example, a data type may define a particular data format (e.g., binary, string, float), a type label (e.g., a field name), one or more associated types, and/or the like for a data element 606 of a particular data type. In some examples, a data type may describe metadata associated with a data element 606 of a particular type. In some examples, a data type may correspond to one or more defined features within a prediction domain. By way of example, in a computer performance domain a data type may define a location, processing speed, memory allocation, resources accessibility bound, and/or the like. As another example, for a clinical domain, a data type may define a price, a price bound, date, and/or the like.

In some embodiments, a data element 606 is an element of a particular data type within a data entry 602 (e.g., a value indexed at a column within a row, a node attribute of a node of a particular node classification). A data element 606 may be comprise a value that describes a characteristic of a data entity. A data element 606, for example, may comprise a data value (e.g., binary, string, float) of a particular type for a data entry 602. For instance, a data element 606 may comprise a numeric, alpha-numeric, textual, value and/or the like. In some examples, a data element 606 may comprise metadata and/or the like that describes a data type and/or one or more data entities that are associated with the data element 606.

In some embodiments, an entry feature 604 is an individually measurable property of a data entry 602 within the dataset. An entry feature 604, for example, may comprise an engineered feature for a data entry 602 that is based on, or derived from one or more data elements of a data entry 602. By way of example, in a clinical domain, an entry feature 604 may comprise a current price (e.g., one of one or more price data elements that is associated with most recent time stamp), an average wholesale price (e.g., an aggregation of a set of wholesale price elements), average wholesale price percentage discount (e.g., an aggregation of a set of wholesale price discount elements), a medication quantity, and/or the like. In some embodiments, a data entry 602 may be associated with a set of independent features and/or one or more dependent features (e.g., performance capacity, a medication pricing level). In some examples, an optimization model may be applied to an input data set to optimize the one or more dependent features of a data entry 602 based on the set of independent features.

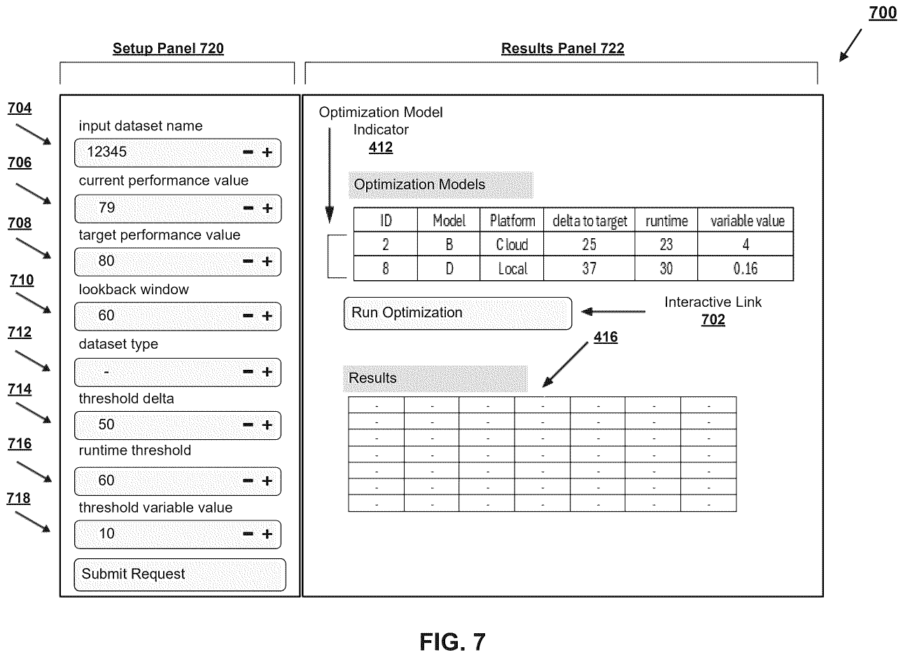

FIG. 7 is an operational example 700 of a user interface in accordance with some embodiments of the present disclosure. As shown in the operational example 700, the user interface may comprise a setup panel 720 and a results panel 722. The setup panel 720 may enable a user to identify an input dataset by an input dataset name 704 and select several input performance parameters. The input performance parameters may comprise one or more of a current performance value 706, a target performance value 708, a lookback window 710, a dataset type 712, a threshold delta 714, a runtime threshold 716, and a threshold variable value 718. The results panel 722 may display one or more optimization model indicators 412, an interactive link 702 to initiate one or more of the optimization models 414 associated with a respective optimization model indicator 412, and results 416 of running an optimization model. The user interface may enable the computing system to provide a visual of options to submit in a request, as well as results 416, to the user.

In some embodiments, a setup panel 720 is part of a display of a user interface. The setup panel 720 may prompt a user to fill out several input performance parameters. The setup panel 720 may comprise several text boxes or selectable options in the form of dropdown boxes or radio buttons to collect the input performance parameters. In some embodiments, the setup panel 720 comprises a button to submit a request once the input performance parameters are entered.

In some embodiments, a results panel 722 is part of a display of a user interface. The results panel 722 may display one or more optimization model indicators 412 once they are determined by computing system 101. In some embodiments, the results panel 722 comprises an interactive link 702 that initiates an optimization model to run using the input dataset. The results 416 of the optimization model may be displayed in the results panel 722 once the run is complete.

In some embodiments, an input dataset name 704 comprises a file name or identifier of an input dataset.

In some embodiments, a current performance value 706 is one of a set of defined input performance parameters for optimizing an input dataset. In some examples, the current performance may describe a current performance of an input dataset. In the context of drug pricing this may be equal to the ingredient cost (current_price multiplied by quantity) expressed as a percentage discount off Average Wholesale Price. This calculation may be based on a predefined timeframe, a user-defined timeframe, and/or the like.

In some embodiments, a target performance value 708 is one of a set of defined input performance parameters for optimizing an input dataset. In some examples, a target performance value 708 may comprise a user or automated agent indicated parameter that indicates a target performance level for the optimization task. In some examples, an optimization model may be configured to update one or more dependent parameters of an input dataset to achieve or be within a defined range of a target performance value 708. By way of example, the target performance value 708 may comprise a performance target calculated based on one or more new independent parameters (e.g., new ingredient cost value expressed as a percentage discount off AWP in a drug context).

In some embodiments, a lookback window 710 is one of a set of defined input performance parameters for optimizing an input dataset. In some examples, a lookback window 710 may describe a time defined by a request that indicates a time period of the input dataset. For example, if the input dataset contains data from 2 months, the lookback window 710 may constrain a target dataset to historical datasets associated with a period of time (e.g., the past two weeks) within the 2-month time period. For example, a lookback window 710 may define a portion of the knowledge database that is accessible for an optimization process. In some examples, the lookback window 710 may correspond to a time period within the time period covered by an input dataset (e.g., days' worth of data within their claims submission). By way of example, if a request identifies a 60-day lookback window 710, an input dataset may be restricted to an input dataset with at least 60 days' worth of data entries.

In some embodiments, a threshold delta to the target performance value 714 is one of a set of defined input performance parameters for optimizing an input dataset. In some examples, the threshold delta to the target performance value 714 comprises a value that defines a threshold distance between a current and target performance value 708. For example, in the case where the current performance value 706 is 82%, the target performance value 708 is 80%, and the delta to target is 10 basis points, then a performance value between 79.9% and 80.1% would satisfy the target performance value 708. In this example, 1 basis point is equivalent to 0.01%.

In some embodiments, a run time threshold is one of a set of defined input performance parameters for optimizing an input dataset. The run time threshold, for example, may identify a time period allocation (e.g., milliseconds, seconds, minutes, hours) for the execution of an optimization model. The time period allocation, for example, may identify a maximum runtime constraint for an optimization model.

In some embodiments, a threshold variable value 718 is one of a set of defined input performance parameters for optimizing an input dataset. The threshold variable value 718 may identify processing resource allocation (e.g., energy consumption cost) for the execution of an optimization model. The processing resource allocation, for example, may identify a maximum variable processing constraint for an optimization model. In some examples, a threshold variable value 718 may be based on the platform or runtime of an optimization model. For example, a locally accessible optimization model may consume local processing resources that may weighted less than remote resources (and/or vice versa), such as an optimization model accessible via a remote Quantum or Cloud platform.

In some embodiments, an interactive link 702 is an interactive interface element that, upon selection, executes a command to perform one or more portions of an optimization process. An interactive link 702, for example, may comprise an interactive interface element that initiates an API call, request, response, and/or the like to one or more optimization services. In some examples, the interactive link 702 may correspond to an optimization model and, responsive to input to the interactive link 702, a computing system 101 may initiate the execution of a corresponding optimization model on an input dataset. In some examples, an interactive link 702 may be provided (e.g., via a user interface) responsive to a determination of an optimization model indicator 412 for a request. In such as case, the interactive link 702, when selected (e.g., by an agent, user) may initiate an execution of an optimization model on an input dataset.

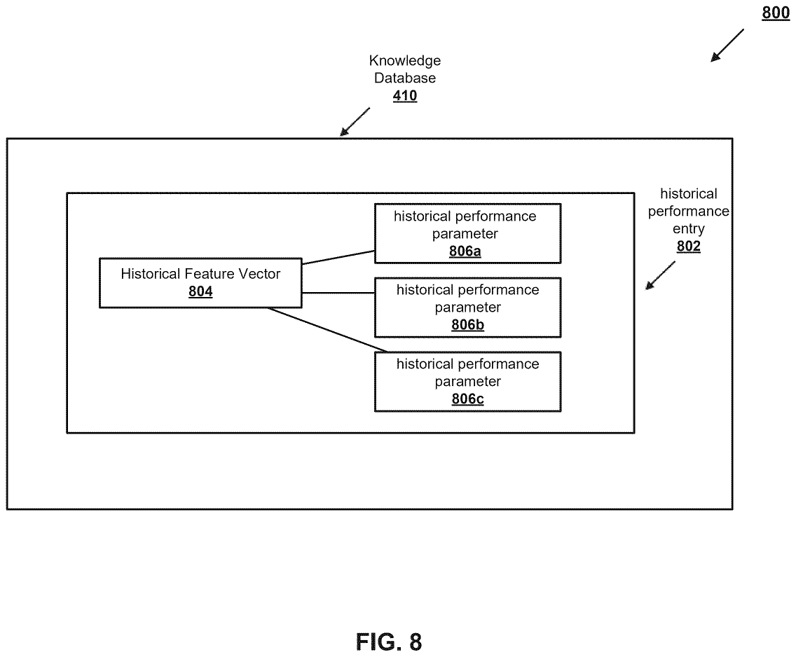

FIG. 8 is an operational example 800 of a knowledge database 410 in accordance with some embodiments of the present disclosure. As shown in the operational example 800, the knowledge database 410 may comprise any number of historical performance entries. A historical performance entry 802 may comprise a historical feature vector 804 and any number of historical performance parameters 806, represented collectively by [##]. A historical feature vector 804 may comprise any number of historical data features of a historical dataset. The structure of the knowledge database 410 may allow for minimized storage to be required to determine the best optimization model for the input dataset.

In some embodiments, a historical feature vector 804 is a vector representation of a historical dataset. A historical feature vector 804, for example, may comprise a plurality of dataset features that describe one or more predictive properties of a historical vector, such as the size of the dataset, data types included in the dataset, a format of the dataset, and/or the like. In some examples, a historical feature vector 804 may comprise one of a plurality of historical feature vectors stored within a knowledge database 410 (e.g., a lookup table) for a particular prediction domain.

In some embodiments, a historical dataset is an input dataset input at a historical time. In some examples, a historical dataset may be stored in the knowledge database 410 as a historical feature vector 804.

In some embodiments, a historical performance parameter (806a-c) is a performance parameter stored in a knowledge database 410 and associated with a historical dataset and/or an optimization model. A historical performance parameter (806a, 806b, or 806c) may specify a recorded runtime, cost, and performance, and/or the like. In some examples, a historical performance parameters 806 may be tailored to a user interface and/or one or more performance parameter options of the user interface. In some examples, a plurality of historical performance parameters 806 may be stored in the knowledge database 410 in association with one or more optimization models 414. In some examples, the historical performance parameters 806 may the enable a determination of a hyper-parametrization of the different optimization models 414 based on one or more historical datasets that the model was previously executed on. The hyper-parametrization of an optimization model may be selected based on the prior runs of that particular model, using the hyper-parameters which reached the target performance value, or were the closest to the target performance value.

In some embodiments, a historical performance entry 802 is a unit of the knowledge database 410. A historical performance entry 802, for example, may correspond to a prior execution of an optimization model on an input dataset. A historical performance entry 802 may be stored and associated with the optimization model to describe a performance of the model with respect to a plurality of different historical datasets. By way of example, a historical performance entry 802 may comprise a representation of a historical dataset (e.g., historical feature vector 804) and one or more historical performance parameters 806. A historical performance entry 802, for example, may comprise (i) a feature-parameter pair that comprises (a) a vector of a plurality of historical features (e.g., entry features, dataset features) and (b) a set of historical performance parameters 806 and (ii) an optimization model identifier that identifies an optimization model used for the historical dataset. The historical performance parameters 806 may comprise a variety of measurable properties of an optimization model, comprising a number of iterations, a number of times the objective function is called, a number of optimizer calculations, a CPU full runtime, a CPU optimization runtime, a GPU full runtime, a GPU optimization runtime, a quantum runtime, a number of quantum queries, a number of times disk write/read, a number of times memory write/read, a number of weight updates (i.e. across all iterations), a final closeness to target, a number of best closeness to target during runtime, a full runtime, a data manipulation runtime, a prepare phase run time, a number of data queries, a number of loops in code, a number of times the loops in code executed, a stability and consistency check, a hyperparameter sensitivity, and/or the like. The historical performance entries may be used to predict how a particular optimization model will perform on an input dataset.

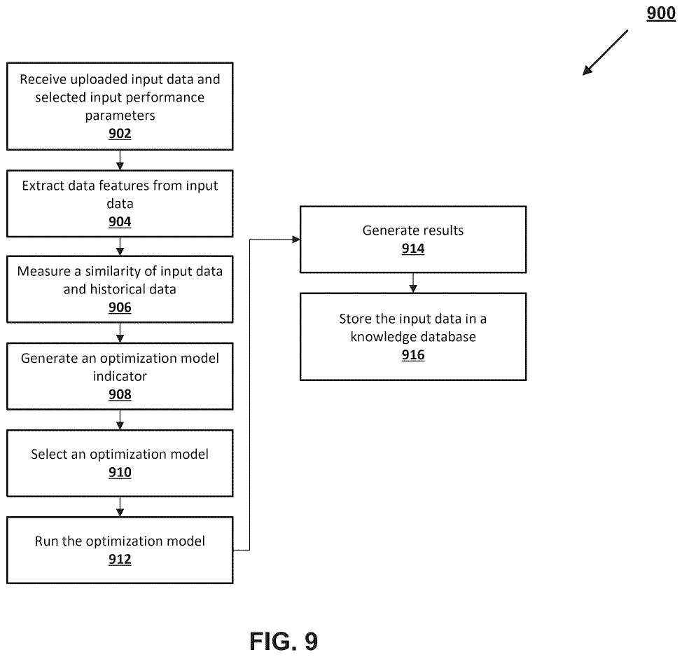

FIG. 9 is a flowchart diagram of an example optimization model determination process 900 in accordance with some embodiments of the present disclosure. The flowchart diagram depicts a process of determining an optimization model indicator based on provided data and historical data. The process 900 may be implemented by one or more computing devices, entities, and/or systems described herein. For example, via the various steps/operations of the process 900, the computing system 101 may generate an optimization model indicator. By doing so, the process 900 improve computer functionality by improving the process of selecting an optimization model that is best for an input dataset, and in turn improving the results provided by the optimization model.

FIG. 9 illustrates an example process 900 for explanatory purposes. Although the example process 900 depicts a particular sequence of steps/operations, the sequence may be altered without departing from the scope of the present disclosure. For example, some of the steps/operations depicted may be performed in parallel or in a different sequence that does not materially impact the function of the process 900. In other examples, different components of an example device or system that implements the process 900 may perform functions at substantially the same time or in a specific sequence.

In some embodiments, the process 900 comprises, at step/operation 902, receiving uploaded input data and selected input performance parameters. For example, the computing system 101 may receive a request that identifies an input dataset and a set of input performance parameters.

In some embodiments, the process 900 comprises, at step/operation 904, extracting data features from the input data. For example, the computing system 101 may extract one or more features of the input dataset.

In some embodiments, the process 900 comprises, at step/operation 906, measuring a similarity of input data and historical data. For example, the computing system 101 may determine a subset of target datasets from a set of historical datasets associated with an optimization model based on a comparison between the one or more features of the input dataset and one or more historical features associated with a historical dataset of the set of historical datasets.

In some embodiments, the process 900 comprises, at step/operation 908, generating an optimization model indicator. For example, the computing system 101 may output an optimization model indicator corresponding to the optimization model based on a comparison between the set of historical performance parameters and the set of input performance parameters.

In some embodiments, the process 900 comprises, at step/operation 910, selecting an optimization model. For example, the computing system 101 may select an optimization model.

In some embodiments, the process 900 comprises, at step/operation 912, running the optimization model. For example, the computing system 101 may, responsive to selection of an interactive link, cause the input dataset to be provided as input to the optimization model.

In some embodiments, the process 900 comprises, at step/operation 914, generating results. For example, the computing system 101 may generate results.

In some embodiments, the process 900 comprises, at step/operation 916, storing the input dataset in knowledge database. For example, the computing system 101 may store, within a knowledge database, a historical performance entry for the optimization model that comprises the set of performance parameters and the one or more features of the input dataset.

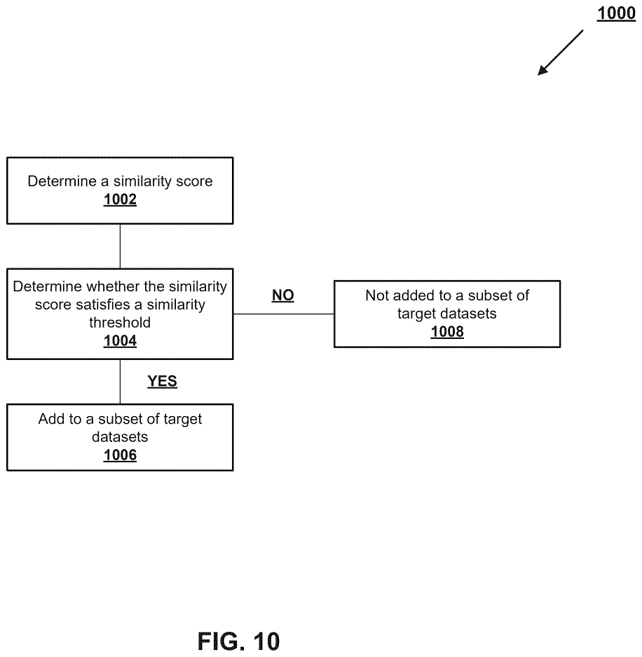

FIG. 10 is a flowchart diagram of an example similarity score process 1000 in accordance with some embodiments of the present disclosure. The flowchart diagram depicts a determination of a similarity score between the input dataset and historical data within the knowledge database and a determination of whether the similarity score satisfies a similarity threshold. The process 1000 may be implemented by one or more computing devices, entities, and/or systems described herein. For example, via the various steps/operations of the process 1000, the computing system 101 may determine whether the similarity score satisfies a similarity threshold. By doing so, the process 1000 improves computer functionality by improving the process for determining a subset of target datasets, based on which the optimization model indicator may be determined.

FIG. 10 illustrates an example process 1000 for explanatory purposes. Although the example process 1000 depicts a particular sequence of steps/operations, the sequence may be altered without departing from the scope of the present disclosure. For example, some of the steps/operations depicted may be performed in parallel or in a different sequence that does not materially impact the function of the process 1000. In other examples, different components of an example device or system that implements the process 1000 may perform functions at substantially the same time or in a specific sequence.

In some embodiments, the process 1000 comprises, at step/operation 1002, determining a similarity score. For example, the computing system 101 may determine a similarity score between the one or more features of the input dataset and the one or more historical features associated with the historical dataset.

In some embodiments, the process 1000 comprises, at step/operation 1004, determining whether the similarity score satisfies a similarity threshold. For example, the computing system may, responsive to the similarity score meeting or exceeding a similarity threshold, add the historical dataset to the subset of target datasets.

In some embodiments, the process 1000 comprises, at step/operation 1006, adding to the subset of target datasets. For example, the computing system 101 may add the historical dataset to the subset of target datasets.

In some embodiments, the process 1000 comprises, at step/operation 1008, not adding to the subset of target datasets. For example, the computing system 101 may not add the historical dataset to the subset of target datasets.

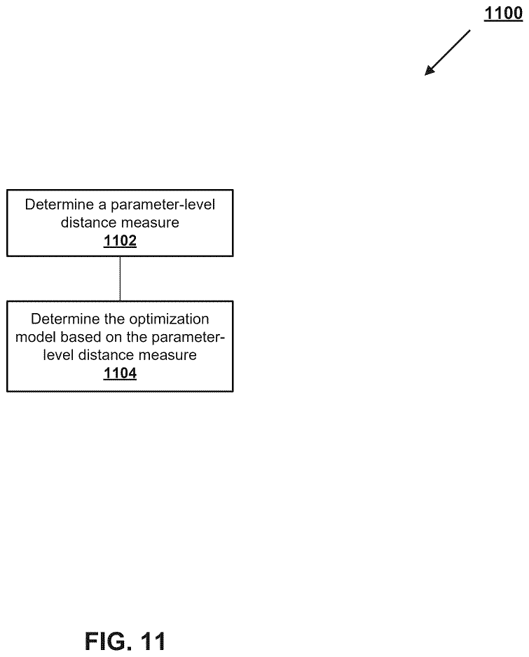

FIG. 11 is a flowchart diagram of an example parameter-level distance measure process 1100 in accordance with some embodiments of the present disclosure. The flowchart diagram depicts a process for determining a parameter-level distance measure and determining the optimization model based on the parameter-level distance measure. The process 1100 may be implemented by one or more computing devices, entities, and/or systems described herein. For example, via the various steps/operations of the process 1100, the computing system 101 may determine a parameter-level distance measure. By doing so, the process 1100 improves computer functionality by improving the selection of the optimization model indicator.

FIG. 11 illustrates an example process 1100 for explanatory purposes. Although the example process 1100 depicts a particular sequence of steps/operations, the sequence may be altered without departing from the scope of the present disclosure. For example, some of the steps/operations depicted may be performed in parallel or in a different sequence that does not materially impact the function of the process 1100. In other examples, different components of an example device or system that implements the process 1100 may perform functions at substantially the same time or in a specific sequence.

In some embodiments, the process 1100 comprises, at step/operation 1102, determining a parameter-level distance measure. For example, the computing system 101 may determine a parameter-level distance measure between a historical performance parameter from the set of historical performance parameters and an input performance parameter of the set of input performance parameters.

In some embodiments, the process 1100 comprises, at step/operation 1104, determine the optimization model based on a parameter-level distance measure. For example, the computing system 101 may determine the optimization model from a plurality of optimization models based on the parameter-level distance.

Some techniques of the present disclosure enable the generation of action outputs that may be performed to initiate one or more real world actions to achieve real-world effects. The techniques of the present disclosure may be used, applied, and/or otherwise leveraged to determine an optimization model indicator responsive to a submitted request. In some examples, the optimization model indicator of the present disclosure may trigger action outputs (e.g., through control instructions) to automate the execution of an optimization model and, responsive to the execution of the optimization model, initiate one or real-world actions, such as the delivery of medications (e.g., in a drug pricing scenario), and/or the like. The action outputs may control various aspects of a client device, such as the display, transmission, and/or the like of data reflective of an alert, and/or the like. The alert may be automatically communicated to a user and/or may be used to initiate the optimization of an input dataset.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. CONCLUSION

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise, a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present), and B is false (or not present), A is false (or not present), and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform all of the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising receiving, by one or more processors, a request that identifies an input dataset and a set of input performance parameters; extracting, by the one or more processors, one or more features of the input dataset; determining, by the one or more processors, a subset of target datasets from a set of historical datasets associated with an optimization model based on a comparison between the one or more features of the input dataset and one or more historical features associated with a historical dataset of the set of historical datasets; extracting, by the one or more processors, a set of historical performance parameters from the subset of target datasets; and outputting, by the one or more processors, an optimization model indicator corresponding to the optimization model based on a comparison between the set of historical performance parameters and the set of input performance parameters.

Example 2. The computer-implemented method of claim 1, wherein (i) the optimization model is one of a plurality of optimization models associated with a knowledge database, (ii) the knowledge database comprises a plurality of historical performance entries for the optimization model that corresponds to the set of historical datasets, and (iii) a historical performance entry of the plurality of historical performance entries comprises a feature-parameter pair that identifies the one or more historical features and one or more historical performance parameters.

Example 3. The computer-implemented method of any of the preceding claims, wherein determining the subset of target datasets comprises determining a similarity score between the one or more features of the input dataset and the one or more historical features associated with the historical dataset; and responsive to the similarity score meeting or exceeding a similarity threshold, adding the historical dataset to the subset of target datasets.

Example 4. The computer-implemented method of claim 3, wherein the similarity threshold identifies a percentile of the set of historical datasets.

Example 5. The computer-implemented method of any of the preceding claims 1, wherein outputting the optimization model indicator comprises determining a parameter-level distance between a historical performance parameter from the set of historical performance parameters and an input performance parameter of the set of input performance parameters; and determining the optimization model from a plurality of optimization models based on the parameter-level distance.

Example 6. The computer-implemented method of claim 5, wherein determining the optimization model from the plurality of optimization models based on the parameter-level distance comprises aggregating a plurality of parameter-level distances that respectively correspond to the set of input performance parameters to generate an aggregate distance measure; determining the optimization model based on a comparison between the aggregate distance measure and a plurality of aggregate distance measures respectively corresponding to the plurality of optimization models.

Example 7. The computer-implemented method of any of the preceding claims, wherein the set of input performance parameters comprises at least two of: a current performance value, a target performance value, a lookback window, a variable level, a threshold delta to the target performance value, a run time threshold, or a threshold variable value.

Example 8. The computer-implemented method of any of the preceding claims, wherein the request is received via a user interface that comprises a toggleable selection icon corresponding to at least one of the set of input performance parameters.

Example 9. The computer-implemented method of claim 8, wherein the optimization model indicator comprises an interactive link that, responsive to selection of the interactive link, causes the input dataset to be provided as input to the optimization model.

Example 10. The computer-implemented method of any of the preceding claims, wherein the one or more features of the input dataset comprises a number of a plurality of dataset entries and one or more entry features associated with a data entry of the plurality of dataset entries.

Example 11. The computer-implemented method of claim 10, wherein the one or more features comprise a number of a plurality of data elements, a data type for a data element, and a key word of the data element.

Example 12. The computer-implemented method of any of the preceding claims, further comprising executing the optimization model using the input dataset to generate a prediction output; recording a set of performance parameters for the optimization model during the execution of the optimization model; initiating, via a user interface, a presentation of the prediction output and the set of performance parameters; and storing, within a knowledge database, a historical performance entry for the optimization model that comprises the set of performance parameters and the one or more features of the input dataset.

Example 13. A system comprising one or more processors; and one or more memories storing processor-executable instructions that, when executed by the one or more processors, cause the one or more processors to perform operations comprising receiving a request that identifies an input dataset and a set of input performance parameters; extracting, by the one or more processors, one or more features of the input dataset; determining a subset of target datasets from a set of historical datasets associated with an optimization model based on a comparison between the one or more features of the input dataset and one or more historical features associated with a historical dataset of the set of historical datasets; extracting a set of historical performance parameters from the subset of target datasets; and outputting an optimization model indicator corresponding to the optimization model based on a comparison between the set of historical performance parameters and the set of input performance parameters.

Example 14. The system of claim 13 wherein (i) the optimization model is one of a plurality of optimization models associated with a knowledge database, (ii) the knowledge database comprises a plurality of historical performance entries for the optimization model that corresponds to the set of historical datasets, and (iii) a historical performance entry of the plurality of historical performance entries comprises a feature-parameter pair that identifies the one or more historical features and one or more historical performance parameters.

Example 15. The system of any of claims 13 or 14, wherein determining the subset of target datasets comprises determining a similarity score between the one or more features of the input dataset and the one or more historical features associated with the historical dataset; and responsive to the similarity score meeting or exceeding a similarity threshold, adding the historical dataset to the subset of target datasets.

Example 16. The system of any of claims 13 through 15, wherein outputting the optimization model indicator comprises determining a parameter-level distance between a historical performance parameter from the set of historical performance parameters and an input performance parameter of the set of input performance parameters; and determining the optimization model from a plurality of optimization models based on the parameter-level distance.

Example 17. The system of claim 16, wherein determining the optimization model from the plurality of optimization models based on the parameter-level distance comprises aggregating a plurality of parameter-level distances that respectively correspond to the set of input performance parameters to generate an aggregate distance measure; determining the optimization model based on a comparison between the aggregate distance measure and a plurality of aggregate distance measures respectively corresponding to the plurality of optimization models.

Example 18. One or more non-transitory computer-readable media storing processor-executable instructions that, when executed by one or more processors, cause the one or more processors to perform operations comprising receiving a request that identifies an input dataset and a set of input performance parameters; extracting, by the one or more processors, one or more features of the input dataset; determining a subset of target datasets from a set of historical datasets associated with an optimization model based on a comparison between the one or more features of the input dataset and one or more historical features associated with a historical dataset of the set of historical datasets; extracting a set of historical performance parameters from the subset of target datasets; and outputting an optimization model indicator corresponding to the optimization model based on a comparison between the set of historical performance parameters and the set of input performance parameters.

Example 19. The one or more non-transitory computer-readable media of claim 18, wherein determining the subset of target datasets comprises determining a similarity score between the one or more features of the input dataset and the one or more historical features associated with the historical dataset; and responsive to the similarity score meeting or exceeding a similarity threshold, adding the historical dataset to the subset of target datasets.

Example 20. The one or more non-transitory computer-readable media of any of claims 18 through 19, wherein outputting the optimization model indicator comprises determining a parameter-level distance between a historical performance parameter from the set of historical performance parameters and an input performance parameter of the set of input performance parameters; and determining the optimization model from a plurality of optimization models based on the parameter-level distance.

1. A computer-implemented method comprising:
receiving, by one or more processors, a request that identifies an input dataset and a set of input performance parameters;
extracting, by the one or more processors, one or more features of the input dataset;
determining, by the one or more processors, a subset of target datasets from a set of historical datasets associated with an optimization model based on a comparison between the one or more features of the input dataset and one or more historical features associated with a historical dataset of the set of historical datasets;
extracting, by the one or more processors, a set of historical performance parameters from the subset of target datasets; and
outputting, by the one or more processors, an optimization model indicator corresponding to the optimization model based on a comparison between the set of historical performance parameters and the set of input performance parameters.

2. The computer-implemented method of claim 1, wherein:
(i) the optimization model is one of a plurality of optimization models associated with a knowledge database,
(ii) the knowledge database comprises a plurality of historical performance entries for the optimization model that corresponds to the set of historical datasets, and
(iii) a historical performance entry of the plurality of historical performance entries comprises a feature-parameter pair that identifies the one or more historical features and one or more historical performance parameters.

3. The computer-implemented method of claim 1, wherein determining the subset of target datasets comprises:
determining a similarity score between the one or more features of the input dataset and the one or more historical features associated with the historical dataset; and
responsive to the similarity score meeting or exceeding a similarity threshold, adding the historical dataset to the subset of target datasets.

4. The computer-implemented method of claim 3, wherein the similarity threshold identifies a percentile of the set of historical datasets.

5. The computer-implemented method of claim 1, wherein outputting the optimization model indicator comprises:
determining a parameter-level distance between a historical performance parameter from the set of historical performance parameters and an input performance parameter of the set of input performance parameters; and
determining the optimization model from a plurality of optimization models based on the parameter-level distance.

6. The computer-implemented method of claim 5, wherein determining the optimization model from the plurality of optimization models based on the parameter-level distance comprises:
aggregating a plurality of parameter-level distances that respectively correspond to the set of input performance parameters to generate an aggregate distance measure;
determining the optimization model based on a comparison between the aggregate distance measure and a plurality of aggregate distance measures respectively corresponding to the plurality of optimization models.

7. The computer-implemented method of claim 1, wherein the set of input performance parameters comprises at least two of: a current performance value, a target performance value, a lookback window, a variable level, a threshold delta to the target performance value, a run time threshold, or a threshold variable value.

8. The computer-implemented method of claim 1, wherein the request is received via a user interface that comprises a toggleable selection icon corresponding to at least one of the set of input performance parameters.

9. The computer-implemented method of claim 8, wherein the optimization model indicator comprises an interactive link that, responsive to selection of the interactive link, causes the input dataset to be provided as input to the optimization model.

10. The computer-implemented method of claim 1, wherein the one or more features of the input dataset comprises a number of a plurality of dataset entries and one or more entry features associated with a data entry of the plurality of dataset entries.

11. The computer-implemented method of claim 10, wherein the one or more features comprise a number of a plurality of data elements, a data type for a data element, and a key word of the data element.

12. The computer-implemented method of claim 1, further comprising:
executing the optimization model using the input dataset to generate a prediction output;
recording a set of performance parameters for the optimization model during the execution of the optimization model;
initiating, via a user interface, a presentation of the prediction output and the set of performance parameters; and
storing, within a knowledge database, a historical performance entry for the optimization model that comprises the set of performance parameters and the one or more features of the input dataset.

13. A system comprising:
one or more processors; and
one or more memories storing processor-executable instructions that, when executed by the one or more processors, cause the one or more processors to perform operations comprising:
receiving a request that identifies an input dataset and a set of input performance parameters;
extracting, by the one or more processors, one or more features of the input dataset;
determining a subset of target datasets from a set of historical datasets associated with an optimization model based on a comparison between the one or more features of the input dataset and one or more historical features associated with a historical dataset of the set of historical datasets;
extracting a set of historical performance parameters from the subset of target datasets; and
outputting an optimization model indicator corresponding to the optimization model based on a comparison between the set of historical performance parameters and the set of input performance parameters.

14. The system of claim 13 wherein:
(i) the optimization model is one of a plurality of optimization models associated with a knowledge database,
(ii) the knowledge database comprises a plurality of historical performance entries for the optimization model that corresponds to the set of historical datasets, and
(iii) a historical performance entry of the plurality of historical performance entries comprises a feature-parameter pair that identifies the one or more historical features and one or more historical performance parameters.

15. The system of claim 13, wherein determining the subset of target datasets comprises:
determining a similarity score between the one or more features of the input dataset and the one or more historical features associated with the historical dataset; and
responsive to the similarity score meeting or exceeding a similarity threshold, adding the historical dataset to the subset of target datasets.

16. The system of claim 13, wherein outputting the optimization model indicator comprises:
determining a parameter-level distance between a historical performance parameter from the set of historical performance parameters and an input performance parameter of the set of input performance parameters; and
determining the optimization model from a plurality of optimization models based on the parameter-level distance.

17. The system of claim 16, wherein determining the optimization model from the plurality of optimization models based on the parameter-level distance comprises:
aggregating a plurality of parameter-level distances that respectively correspond to the set of input performance parameters to generate an aggregate distance measure;
determining the optimization model based on a comparison between the aggregate distance measure and a plurality of aggregate distance measures respectively corresponding to the plurality of optimization models.

18. One or more non-transitory computer-readable media storing processor-executable instructions that, when executed by one or more processors, cause the one or more processors to perform operations comprising:
receiving a request that identifies an input dataset and a set of input performance parameters;
extracting, by the one or more processors, one or more features of the input dataset;
determining a subset of target datasets from a set of historical datasets associated with an optimization model based on a comparison between the one or more features of the input dataset and one or more historical features associated with a historical dataset of the set of historical datasets;
extracting a set of historical performance parameters from the subset of target datasets; and
outputting an optimization model indicator corresponding to the optimization model based on a comparison between the set of historical performance parameters and the set of input performance parameters.

19. The one or more non-transitory computer-readable media of claim 18, wherein determining the subset of target datasets comprises:
determining a similarity score between the one or more features of the input dataset and the one or more historical features associated with the historical dataset; and
responsive to the similarity score meeting or exceeding a similarity threshold, adding the historical dataset to the subset of target datasets.

20. The one or more non-transitory computer-readable media of claim 18, wherein outputting the optimization model indicator comprises:
determining a parameter-level distance between a historical performance parameter from the set of historical performance parameters and an input performance parameter of the set of input performance parameters; and
determining the optimization model from a plurality of optimization models based on the parameter-level distance.
